(19) United States
(12) Patent Application Publication
(10) Pub. No.: US 2002/0183960 A1
(43) Pub. Date: Dec. 5, 2002

(54) Method and system for estimating subject position based on chaos theory

(76) Inventors: Ta-gang Chiou, Cambridge, MA (US); Yih-Yuh Chen, Taipei (TW); Tsung-Hsun Yang, Taipei (TW)

Correspondence Address: Chiou, Ta-gang, Suite 8-6A, 100 Memorial Drive, Cambridge, MA, 02142, US

(21) Appl. No.: 10/136,156

(22) Filed: May 1, 2002

Related U.S. Application Data
(60) Provisional application No. 60/287,749, filed on May 2, 2001.

(51) Int. Cl. G06F 15/00

(52) U.S. Cl. 702/150

(57) ABSTRACT

A method and system for estimating a subject's position is provided by taking in a time series of a subject's positional data, analyzing the data to extract their crucial features, reconstructing the inherent dynamics, and then storing the data in mathematical transformations which not only can compress the amount of data needed to reliably reproduce the past history, but also can make estimations on the subject's position at a specific time.

### CROSS-REFERENCE TO RELATED APPLICATIONS

This application is entitled to the priority benefit of Provisional Patent Application Ser. No. 60/287,749, filed on May 02, 2001.

### BACKGROUND

1. Field of Invention

The present invention relates generally to a method and system for estimating the position of a subject and, in particular, to a method and system for estimating the position of a subject based on the mathematics of Chaos Theory.

2. Description of Prior Art

There are many kinds of methods to pinpoint a subject's position. Examples include positioning systems deployed in the cellular phone network, such as U.S. Pat. Nos. 5,612,703 (1997), 5,613,205 (1997), 5,675,344 (1997), 5,764,188 (1998), 5,943,014 (1999), 6,163,696 (2000), or U.S. Pat. Nos. 4,667,203 (1987), 5,043,736 (1991), 5,724,660 (1998) which use the Global Positioning System (GPS) or satellites to get the subject position and report the result via wireless data transmission channel. All these methods could be used to provide the subject's current position, but they are not able to predict a subject's position in the near future. Furthermore, the storage of the data collected upon a subject's position in a series of time will require a vast amount of computer disk space. This invention could hold the ability to solve these prediction and storage problems based on the mathematics of Chaos Theory. This invention can assist in estimating a subject's position and compressing a time series of positional data of the subject.

### BACKGROUND OF THE INVENTION

Intuitively, one might hardly believe that simple patterns in a time series of position information of a subject may be easily identified, given the fact that routine chores in one's daily schedule are frequently interrupted by unexpected events which either require immediate care or will necessarily alter one's plans for the near future, thus totally changing the perspective route one would take if there were no such interferences. Added to this intrinsic difficulty is the fact that every individual is actually interacting with numerous people surrounding him/her in a voluntary and non-voluntary way so that the underlying complexity in the movement of a person may be so strongly coupled to all these factors that any attempt to resolve the patterns might simply be too much to ask for. In mathematical terms, one might view the resultant time series of positional data as a mere projection of a virtually infinite-dimensional dynamical system. These seemingly formidable characteristics of the positional data then pose a serious issue to companies or agencies which (either by law or by necessity) must keep a historical copy of a certain subject's whereabouts or are forced to make predictions of the subject's present position when only a portion of the position was recorded and available. The apparent random fluctuations seen in the data on the subject's position also present difficulties if one is to make predictions based on those figure. On the other hand, situations like this are not uncommon in the study of many physical systems of which the apparent complexity also demands an almost infinite number degrees of freedom to completely specify its state. For instance, in the famous Rayleigh-Bénard convection cell, one must deal with the complex dynamical interactions between the hotter rising water molecules and the colder descending molecules, and yet under certain conditions one discovers that as few as three scalar variables are all that are needed to capture the basic physics involved and give a quantitatively correct prediction of the system behavior, even though its convectional dynamics still appears chaotic.

The reason why we can use a highly reduced set of equations to describe the time evolution of a supposedly very high dimensional dynamical system is that real systems usually are dissipative in nature; most of the degrees of freedom actually play no role in determining the ultimate long term behavior of the system. If, for one reason or another, the human society also exhibits dissipative features, then it is not inconceivable for the measurement of a certain human activity indicator to also show the characteristics of a low-dimensional system. In this case, one can hope to obtain a good description of that indicator using only a limited set of data. In other words, a system can appear rather complex either because it is intrinsically consisted of many degrees of freedom or because the time evolution of a system variable tends to look erratic. But, careful scrutiny might reveal the fact that the relevant degrees of freedom are very limited in scope; therefore, a deterministic model with only a few variables is enough to represent the dynamics of the system. This is the basic philosophy underlying the present invention.

As an instance, we found that the seemingly random fluctuations in the behavior of a two-dimensional traveler going about between his/her home and work places and other places as required by the daily chores the subject had to perform agreed with the assumption that it could be successfully modeled by a low-dimensional dynamical system.

This suggests that the mobile pattern exhibited by possibly complex human activities is just another manifestation of the deterministic chaos shared by many physical systems. As a result, we found that techniques of Chaos Theory developed for the treatment and analysis of other physical systems can be adapted to solve the problem of storing the records of human position in a cost-effective way and of estimating or predicting the future trajectory of the subject's position.

### SUMMARY

The objective of the present invention is to provide a method and system which can be effectively used to analyze a time series of a subject's positional data and estimate the subject's possible position at a specific time, or to reliably compress the pertinent data and efficiently retrieve the data when called for. The present invention proposes a method and system for estimating a subject's position by taking a time series of a subject's positional data, extracting the crucial features of the analyzed data, reconstructing the inherent dynamics, and then storing the data in mathematical transformations which not only can compress the amount of data needed to reproduce the past history, but also can makes estimations on the subject's position at a specific time.

An aspect of the present invention resides in a position estimation method which comprises the steps of: collecting a time series of positional data of a subject; reconstructing the model of the positional data according to Takens' Embedding Theorem; based on the reconstructed model, estimating the subject's position or storing the compressed subject's positional data.

Another aspect of the present invention resides in a position estimation system which comprises a memory module for collecting a time series of positional data of a subject, a model reconstructing module which reconstructs phase space model of positional data according to Takens' Embedding Theorem, an estimating module to estimate the subject's position, or a storing module used to store the compressed positional data.

### DESCRIPTION OF DRAWINGS

This invention is pointed out with particularity in the appended claims. The above and further advantages of this invention may be better understood by referring to the following description taken in conjunction with the accompanying drawings, in which:

FIG. 1 shows a flowchart of one embodiment of the method;

FIG. 2 shows a block diagram of an embodiment of a system implemented with the method;

FIG. 3 shows a block diagram of a networked system on which the method and system may be used.

FIG. 4a shows the average mutual information of a sample time series of random signal.

FIG. 4b shows the average mutual information of a typical time series of chaotic signal.

FIG. 4c shows the average mutual information of a sample time series of positional data of a subject.

FIG. 5a shows the singular value decomposition (SVD) of a sample time series of random signal.

FIG. 5b shows the singular value decomposition (SVD) of a typical time series of chaotic signal.

FIG. 5c shows the singular value decomposition (SVD) of a sample time series of positional data of a subject.

FIG. 6a shows the phase space model of a sample time series of random signal.

FIG. 6b shows the phase space model of a sample time series of chaotic signal.

FIG. 6c shows the phase space model of a sample time series of positional data of a subject.

FIG. 7 is an explanatory view for explaining the estimating position process.

### DESCRIPTION OF INVENTION

The investors of the present invention found that the time series of the positional data of a subject can be described by the mathematics of Chaos Theory, on the basis of analysis performed on real-world positional data of individuals and collectives. The present invention makes use of Chaos Theory based computer analysis and relates to a system and method for effectively storage of a subject's positional data recorded by the global positioning system (GPS) or any other system capable of providing position information of the subject, and estimating the near trajectory of the same subject at a certain time once a time series of the subject's positional data is known.

As referred to in this description, the term “subject” is defined as a subject with mobility. Examples of such subjects include human beings, vehicles driven by people, or other devices having a mobile pattern controlled by human beings. An example of such device is a cell phone that is carried by a user. A subject can also be a collective of people associated with a certain vehicle or equipment. Examples of such subjects include a bus carrying many people, and a collective of cell phone users being served in a service area of a mobile communication network.

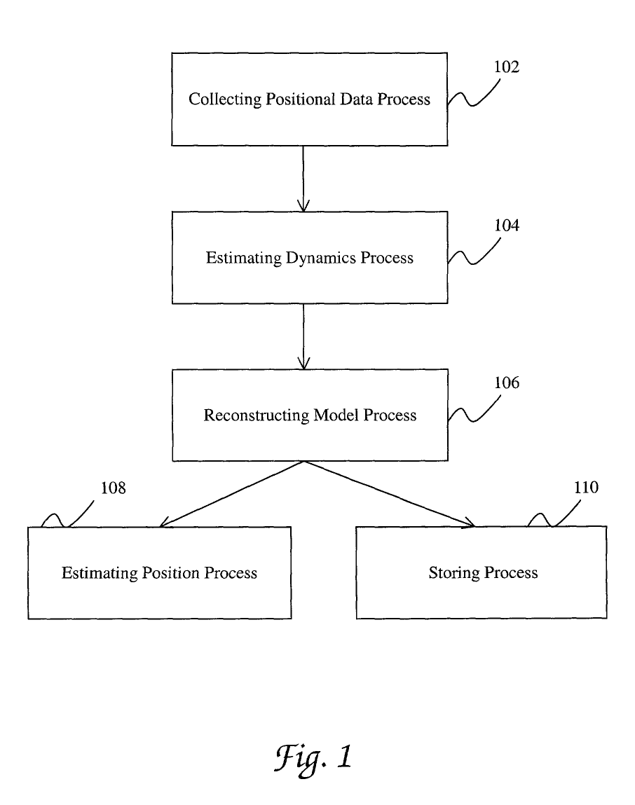

Referring now to FIG. 1, which shows the flowchart of one embodiment according to the method of the present invention.

In the first step 102, a process of collecting a time series of positional data of a subject is performed. The time series of positional data, which consists of the subject's positional records and the time the positions are determined, is recorded in a memory device. The positional records may be of different formats, such as the longitude and latitude, a cell ID in a cellular network, or a point in a user-defined coordinate, determined by using various technologies or measurements including, but not limited to, positioning devices such as a Global Positioning System, a positioning system in a cellular network, and a vehicle tracking system. Because mathematically speaking the transformation of a chaotic signal can still be chaotic, the positional data may also be in the form of transformed signals resulted from a collective's movement. For example, the positional data of a collective amount of people may be recorded by several base stations in the form of the number of cell phone users being served in the service area of each base station. Examples of such signals include handover counters and location updating counters, recorded by base stations continuously in a cellular system. The subject positional data can be recorded in any type of memory means capable of recording the positional records. Examples of such memory devices include hard drives, disk arrays, and Random Access Memories (RAMs).

The invention also includes means to overcome missing or discontinuous set of a time series data. Inability to get a complete set of data over a regular period reflects a realistic limitation set up by the real world; Sometimes the subject might be passing through a tunnel or staying inside of a building, for which case GPS communication was simply blocked. Sometimes, a dead battery or running out of memory can be blamed for the termination of the recording process. Also, the subjects might be instructed to follow their usual habits of turning off their receivers while at rest, as likely would be the case for many people.

Although in principle the reconstruction of the dynamics does not require the measured data to be sampled at a regular time interval, in practice it is awkward to get a sensible result if we leave the data the way they are for the purpose of reconstruction. In our invention, one embodiment to rectify the problem of missing data is to use a linear interpolation scheme to make up the gaps left by missing data before reconstructing the model. This interpolation scheme is not expected to cause much error in most cases simply because of the two facts:

(1) If the gap is not wide, then it means the loss in data is probably caused by a temporary blocking of the communication channel; and during this short period of time the subject is not expected to have moved a long distance so that linear interpolation suffices to satisfactorily fill in the gap.

(2) If the gap is wide, then most likely the receiver is in power off condition. Since usually this implies that either the carrier is staying at the same place for a prolonged period of time, so that (s)he would not be needing any GPS update information, or that (s)he might be traveling between cities on a public transportation, the linear interpolation scheme probably will still has its validity. Nevertheless, other interpolation schemes or ways to fill in the missing data can also work well, depending on the nature of the gap.

Once the process for collection a time series of positional data is done, we can use the mathematics of Chaos Theory to estimate a subject's position. An embodiment of said mathematics of Chaos Theory is to estimate the dynamics of the positional data and then reconstruct the phase space model. The dynamics may include the preferred time delay and embedding dimension of the positional data. The dynamics will then be used to employ Takens' Embedding Theorem to reconstruct phase space model.

Step 104, the estimating dynamics process, includes means to calculate the most suitable delay time T, and the embedding dimension D.

We utilized an information-theoretic quantity, the mutual information, to justify the preference of a certain T. In general, the mathematics valid for one particular choice of T generally will also be true for another value of T, but we prefer to find a suitable T which may help increase the accuracy of the invention. On one hand, if this time delay T is too short, the coordinates x(t) and x(t+T) which we wish to use in our reconstructed vector yₖ will not be independent enough, because, by assumption, our governing equation is an ordinary differential equation which implicitly assumes that the system variable at the very next moment is intimately related to the variable value at this moment. This is to say that not enough time is allocated to the system for it to have explored a large enough portion of its state space to produce, in a practical way, new information about that phase space point. On the other hand, we would not want to use a very large T either. For example, since chaotic systems are intrinsically unstable, if T is too large, any connection between the measurements s(n) and s(n+T) is numerically tantamount to being random with respect to each other. Even very accurate determinations of the value s(n) cannot prevent the exponential growth of small errors characteristic of chaos from decorrelating it from the measurement T steps later, when T becomes large. For this reason, we have included a criterion to discriminate between proper and improper choices of T. However, we should note that this criterion is chosen for convenience only and does not constitute a requirement of this invention. That is, the present invention will work equally well if one implements a convenient method other than the average mutual information described below to select the proper time interval T. This is particularly true if the plot of the average mutual information as a function of the delay time T does not exhibit a prominent minimum.

The criterion we adopt is achieved by incorporating the idea of average mutual information, which is a function of the delay time T. As suggested by A. M. Fraser, we will choose T such that it corresponds to the first minimum of the average mutual information defined below.

For a time series s(n) and its time-delayed copy s(n+T), the average mutual information between two measurements, that is, the amount of information (in bits) learned by the measurements of s(n) through the measurements of s(n+T) is

$$I ( T ) = {\sum }_{s ( n ) , s ( n + T )} P ( s ( n ) , s ( n + T ) ) {log}_{2} [ \frac{P ( s ( n ) , s ( n + T ) )}{P ( s ( n ) ) P ( s ( n + T ) )} ]$$

where P(ε) is the probability of finding the observable to be of value ε when we do the experiment. Likewise, P(ε, η) is the joint probability of finding one at the ε state and another at η. When T becomes large, the chaotic behavior of the signal makes the measurements s(n) and s(n+T) independent in a practical sense so that I(T) will tend to zero. One can use the function I(T) as a kind of nonlinear autocorrelation function to determine when the values of s(n) and s(n+T) can be considered as independent enough of each other to be useful as coordinates in a time delay vector but not so independent as to have no connection with each other at all. This is why the time T which gives rise to the minimum of I(T) has been adopted as the optimal choice of the delay time. One other reason this might be a good criterion has to do with the fact that I(T) is invariant under diffeomorphism, meaning that it has the same value whether we use the original dynamics or the reconstructed dynamics to evaluate it.

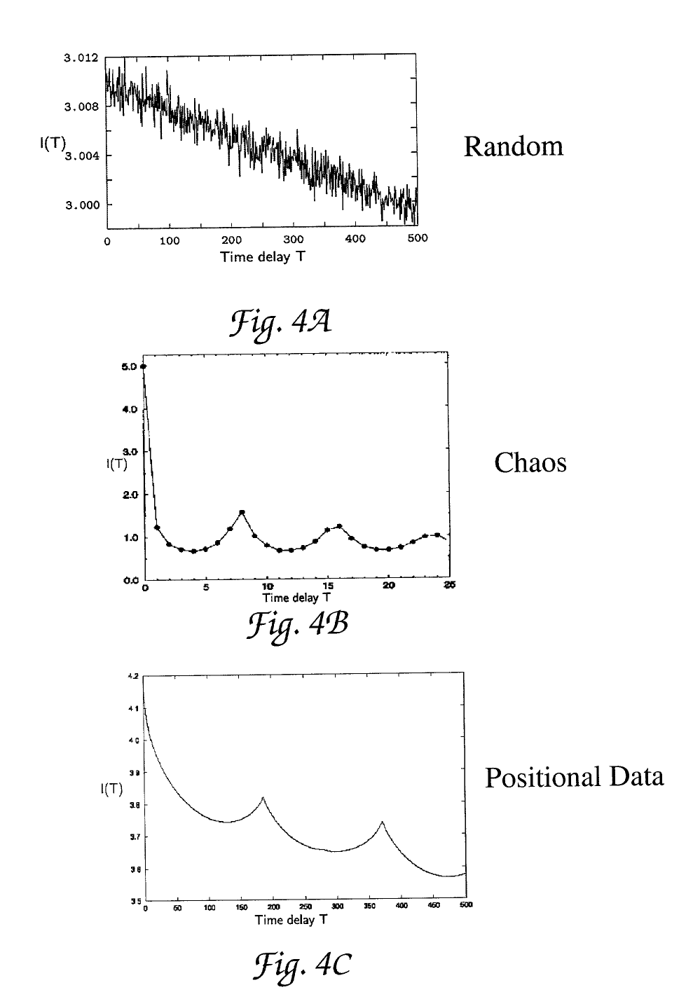

We have also verified that the average mutual information of a time series of positional data shows similarity to that of chaotic signals. FIGS. 4a to 4c show the average mutual information of a sample time series of random signal, chaotic signal, and positional data of a subject, respectively.

To determine the smallest admissible dimension for the embedding space U, we need to decide when it is appropriate for us to stop adding more components in the vector Yₖ defined above. This can be done in several ways, including the global false nearest neighborhood advocated by M. B. Kennel and co-workers and the more standard singular value decomposition (SVD) method. The invention works well regardless of which method we use to determine the dimension.

In a preferred embodiment, we adopt the SVD method as the basis for the determination of the minimal embedding dimension. In the previous paragraphs we have demonstrated that adding more components into the reconstructed vector yₖ will not increase the degree of freedom of the reconstructed attractor if we have exhausted the physical dimension of the original attractor. This means that the number of linearly independent vectors we can obtain out of the series y₁, y₂, . . . can not increase even if we append more columns to each yₖ. Thus, by studying the range of the matrix A constructed from putting all the yₖ's in juxtaposition, as defined below, we will be able to reveal how big its range is:

$$A ≡ ( \begin{matrix}{y}_{1}^{T} \\ {y}_{2}^{T} \\ {y}_{3}^{T} \\ ⋮ \\ {y}_{M}^{T}\end{matrix} )$$

The dimension of its range then becomes the effective embedding dimension sought for in the first place.

Our embodiment of this SVD method incorporates additional considerations to overcome the problem that the actual data one uses in this construction are unavoidably contaminated by noises from all sources such as measurement errors and round-off errors. What this means is that, in a strict mathematical sense, the dimension of the range of A indeed increases indefinitely if we keep on adding more components to the constituent yₖ's. This, however, does not pose a real difficulty because, when viewed as a linear operator mapping one sphere in the space U to an ellipsoid in another space, A does not extend appreciably along the extraneous dimensions incurred by the noises. In other words, the resultant ellipsoid is very flat; and the flatness is resulted entirely from the small amount of noises accompanying the added components of the column vector yₖ. Therefore, if we compute the lengths of the major axes of the ellipsoid, only a finite number 1 of them will have an order of unity while all the others remain rather small. The number 1 corresponds to nothing but the embedding dimension we were seeking. Algorithmically, then, we implement the following:

A=U_{M×M}D_{M×N}V_{N×N}

where U_{M×M} and V_{N×N} are orthogonal matrices and D_{M×N} is a diagonal matrix whose diagonal matrix elements may be put in descending order

d₁≧d₂≧ . . . ≧dₗ>>dₗ₊₁≧ . . . ≧d_{M}≈0

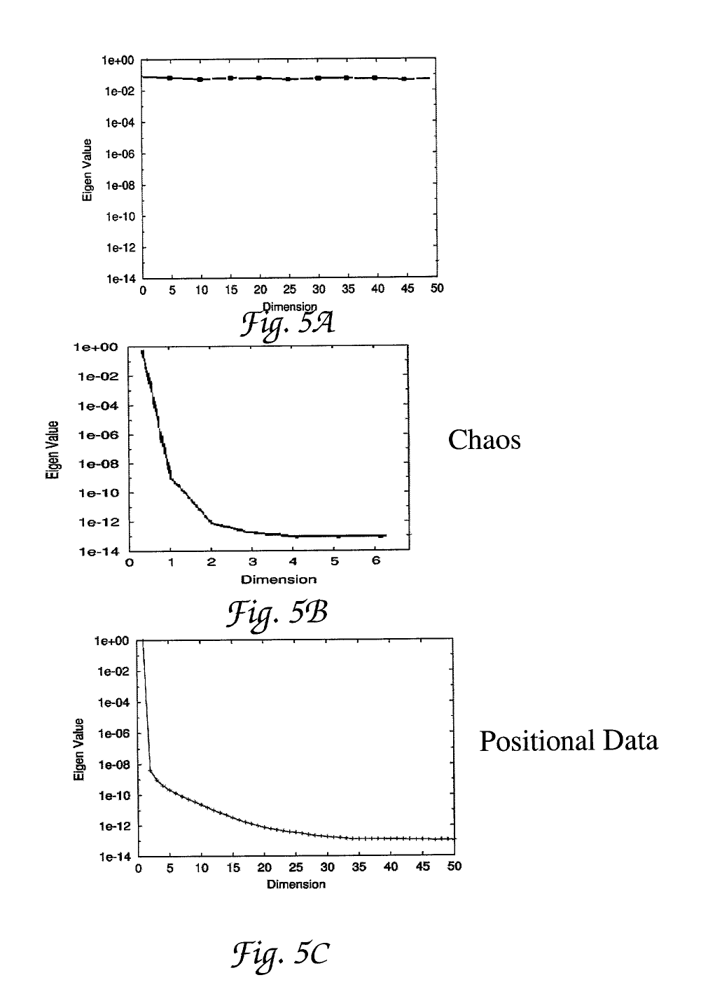

We have also verified that the SVD plot of a time series of a subject's positional data shows similarity to that of chaotic signals. FIGS. 5a to 5c show the SVD plots of a sample time series of random signal, chaotic signal, and positional data of a subject, respectively. Based on our SVD analysis performed on a group of more than six subjects, ranging from students to sales, engineers, and administrators, over more than six months, it is interesting to note that an embedding dimension of mere 3 seems quite enough to capture their mobile patterns, even though they each apparently follow a very different work habit.

The calculated time delay and embedding dimension can then help step 106, reconstructing phase space model of positional data. The following gives a concise account of how Takens' theorem can be implemented and why the method is plausible. According to Takens' theorem, a deterministic dynamical system whose evolution is described by

dxₙ₊₁/dt=ƒ(xₙ), xⱼεV

for a D-dimensional vector x_{J} in the vector space V generically can have its attractor reconstructed in another phase space U if the dimension N of U is no less than 2D+1. In particular, if the only measurements available to one are those made of the single variable sₙ=g(xₙ) for some function g, where xₙ=x(nT), then one can try the following delay coordinate:

yₖ≡(sₖ,sₖ₊₁, . . . ,s_{k+N+1})^{T}εU

The assertion of the theorem is: Generically the series of the vectors yₖ will describe a geometrical object which has the same topology of the original system. Furthermore, the points y₁, y₂, . . . correspond exactly to x₁, x₂, . . . In one embodiment, one can try taking sₖ to be either the x or the y coordinate of a subject's position.

To understand why this prescription is capable of reconstructing the phase space, we notice that yₖ may be thought of as a vector function y(x) defined for every vector x in U. Thus, y( ) maps every D-dimensional vector in the space V into another vector in the space U. The geometrical object in U one obtains via this mapping can have a dimension never greater than D. In order for this mapping to be always one-to-one so that we have a guarantee on the topological equivalence of the reconstructed object with its original copy in the space V, we must require the object to be non-self-intersecting.

But in order for this geometrical object not to intersect itself in U, the underlying space U should have a dimension at least greater than 2D in the worst case. For instance, a one-dimensional curve can cross itself, and this self-intersection generally cannot be removed by slightly perturbing it if it is placed in a two-dimensional space. But if it is placed in a three-dimensional space so that we are allowed to lift a segment slightly off the plane, then the self-intersection is effectively resolved. Hence, a space U of a dimension not smaller than 2D+1 is what one will need for the successful reconstruction of the dynamics.

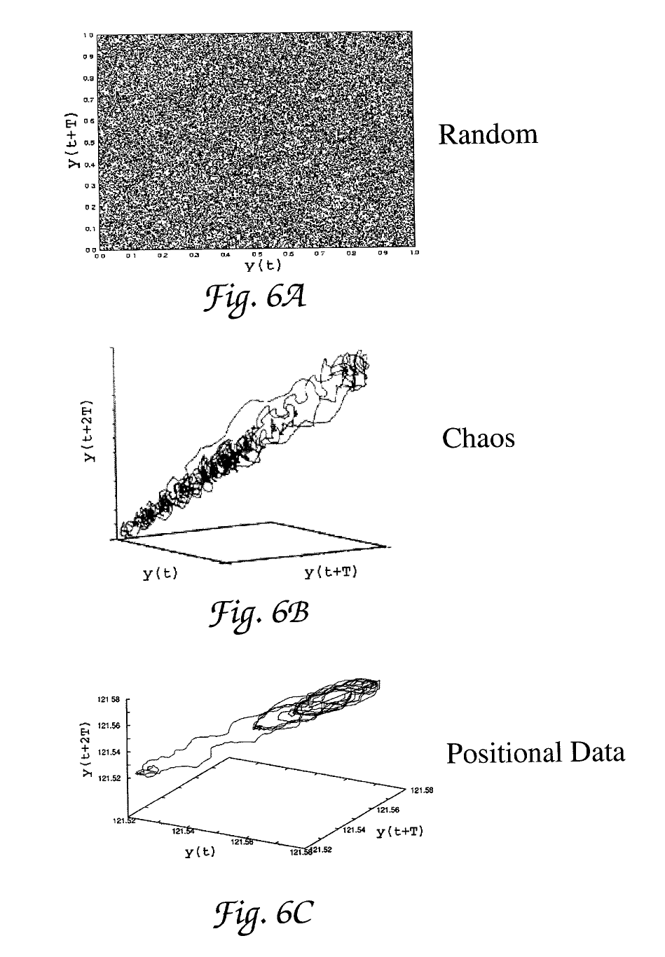

The invention also includes a means for dynamically updating or adjusting the reconstructed model with new or incoming positional data. This is achieved by comparing the difference between new positional data and the estimated position for the same period of time. In one embodiment, if the difference is larger than a predetermined value, a new model will be reconstructed based on the new data. In another embodiment, the update of model is incremental, which means that the model can contain more and more details by projecting the new positional data to the phase space, without the need to run the whole reconstructing process from the beginning. FIGS. 6a to 6c show phase space models, reconstructed based on the time delay and dimension chosen as described earlier, of a sample time series of random signal, chaotic signal, and positional data of a subject, respectively. We have found that the reconstructed model of a time series of positional data exhibits similar characteristics as that of a typical chaotic signal.

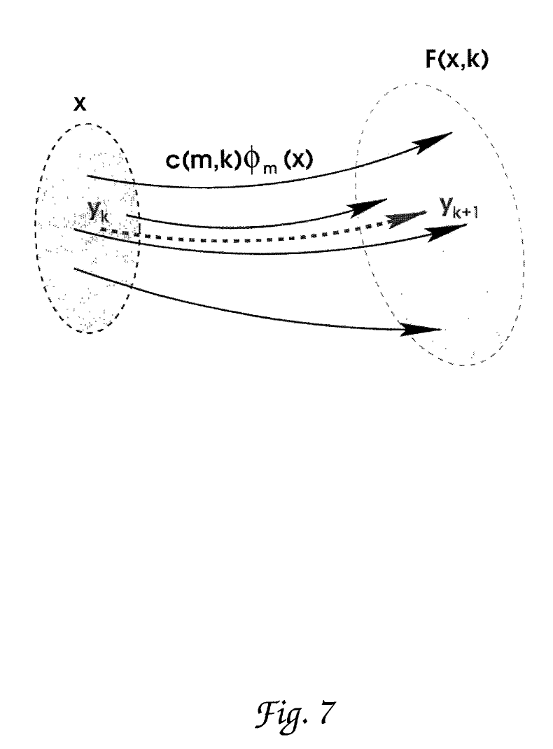

Step 108 estimates the position of a subject based on reconstructed model. Referring to FIG. 7, the basic idea behind the estimation or prediction is described below. First, for any point yₖ we assume that a local function F(x,k) exists which maps a point x near yₖ to some point F(x,k) near yₖ₊₁. To avoid complications, we may assume the local functions defined in the neighborhood of every point yₖ to have the same form, but with adjustable parameters to account for their individuality. For instance, having chosen an appropriate set of “basis functions ∅ₘ(x) for m=1, 2, . . . , L for some integer L, we may proceed to determine a most suitable set of coefficients c(m,k) so that

$$F ( x , k ) = {\sum }_{m = 1}^{M} c ( m , k ) {φ}_{m} ( x )$$

is a good representation of how points near yₖ are mapped to their new positions for the next moment. Traditionally one will simply choose polynomials for the ∅ₘ(x)'s, though other choices might be equally good as long as they serve their purposes. The discussion of what functions to use and how many to use is the subject of multi-dimensional interpolation. If we have enough data, local polynomial approximations to the dynamics will provide accurate local maps. But when the data become sparse or the dimensions become high, one might need a relatively large number of terms to provide a good local approximation. In this case, other techniques need to be developed to take care of this situation. In our implementation, it turns out to be quite sufficient to just use linear maps.

In one embodiment, the determination of the coefficients can be effected using a least square fit or other methods with similar purpose. For instance, suppose we have partitioned the reconstructed space into different neighborhoods and assume that Yᵣ happens to lie inside a neighbor-hood NB containing yₖ, then we will determine the c(m,k) by requiring the following quantity to be minimized:

$${\sum }_{{y}_{r} ∈ {N}_{B}} \vert {y}_{r + 1} - {\sum }_{m = 1}^{M} c ( m , k ) {φ}_{m} ( {y}_{r} ) {\vert}^{2}$$

This procedure uniquely determines all the coefficients in a given neighborhood. Once every local mapping has been determined, one can readily make a prediction if a certain point x happens to lie inside NB: The future orbital point of x can then be predicted based on this equation.

Note that this approach is not only useful for predicting, but can also be used to estimate the subject's position in the past, present, or future, if a neighboring time series of positional data is provided.

Step 110 is the storing process, which stores information we gathered in the analyzing process in a compressed manner. Specifically, all the raw data points can be replaced by the mapping information gathered in the analyzing process. This amounts to storing the neighborhood information (their centers and radii) of each NB constructed above together with the best-fit coefficients c(m,k). Because a potentially infinite number of points can be fit inside a neighborhood, our invention of using the simple information contained in both NB and c(m,k) to represent the future time evolution of the data points clearly has become a very cost-effective but lossy method of storing the huge amount of data. It is a lossy scheme in the sense that it does not necessarily reproduce the exact data used to establish the model, but only closely approximates them, as with all the other data points. For a set of sample data we have collected, we used a cubic neighborhood of side 100 meters. Since D=3, we will need 3×3 parameters for the c(m,k) of each local map for either the longitude or the latitude information. In addition, we also need an extra 3 parameters to uniquely specify the position of each neighborhood which actually contains the measured data. To encompass all the 50,000 data points we have used in the analysis, a total number of 1000 neighborhoods of the specified side are needed. We thus use (9+3)×1000=12,000 data to represent the original data, resulting a compression ratio of about 4:1 in the data storage.

An uncompressing process can be achieved by reversing the compressing process. In one embodiment, the process comprises of reading yₖ and the related c(m,k) from the stored file, choosing the last data of yₖ to start up the forward recovery according to the estimating process with forward mapping, and choosing the first data of yₖs to start up the backward recovery according to the estimating process with backward mapping.

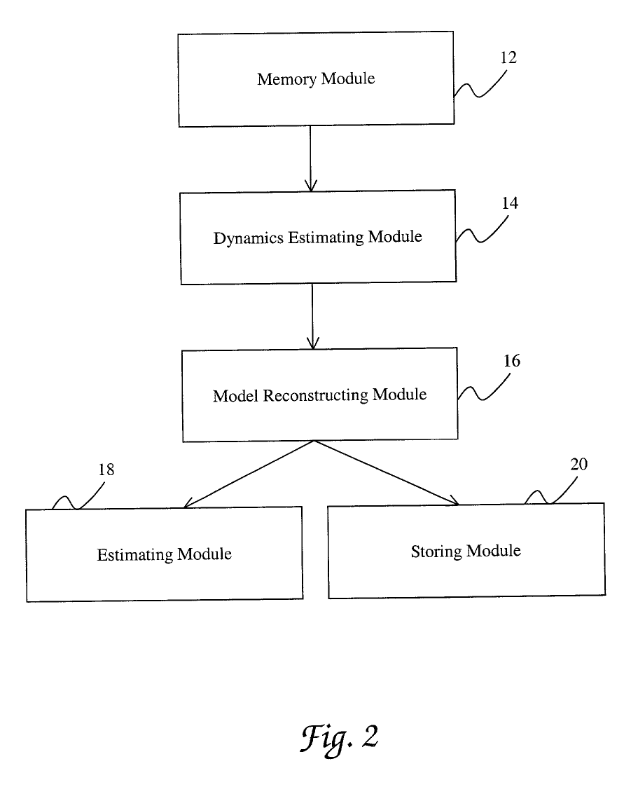

Another aspect of the invention could be comprised of the following modules, as shown in FIG. 2:

A memory module 12 is used to store a time series of pre-recorded positional data of a subject.

A dynamics estimating module 14 can calculate the dynamics, such as the preferred time delay and dimension of the positional data. The choice of the preferred delay time T is made feasible by evaluating the first minimum of the mutual information of the data points as a function of T. The preferred embedding dimension D is then computed using methods such as singular-value decomposition (SVD).

A model reconstructing module 16 which maps the data stored in the memory module into points in some judiciously chosen higher-dimensional space (the reconstructed space) so that the internal dynamics generating the recorded movement data is put into a one-to-one correspondence with that in the reconstructed space. This is achieved by applying the embedding theorem of Takens, which states that a suitably chosen delay coordinate (s(jT), s(j+1)T), . . . , s((j+D−1)T)) for the time series s(0), s(T), . . . , s(nT), . . . of an observed signal s(t) can be used to reconstruct a dynamical system in the reconstructed space so that the dynamics in that space is topologically equivalent to the original dynamics.

An estimating module 18 is used to resolves the local data at one instant and maps them into the data for the next moment. The mapping function then serves as a means for estimating the most likely position of the same subject at a different time if the subject's position near the time is known. Because the mapping is local in nature, we may simply use a linear map to achieve our task.

A storing module 20 is used to save the mathematical content contained in the mapping functions of the estimating module so that the original time series can be effectively compressed in a format which does not require the actual recording of the time series. The stored parameters for this purpose are not the data per sé, but the linear transformations we constructed in the estimating module. This can be potentially a very efficient way to save the original data in a lossy way because the number of matrix elements in the reconstructed space is very small in number, whereas the data points falling into a neighborhood for which the linear transformation is valid can be enormous.

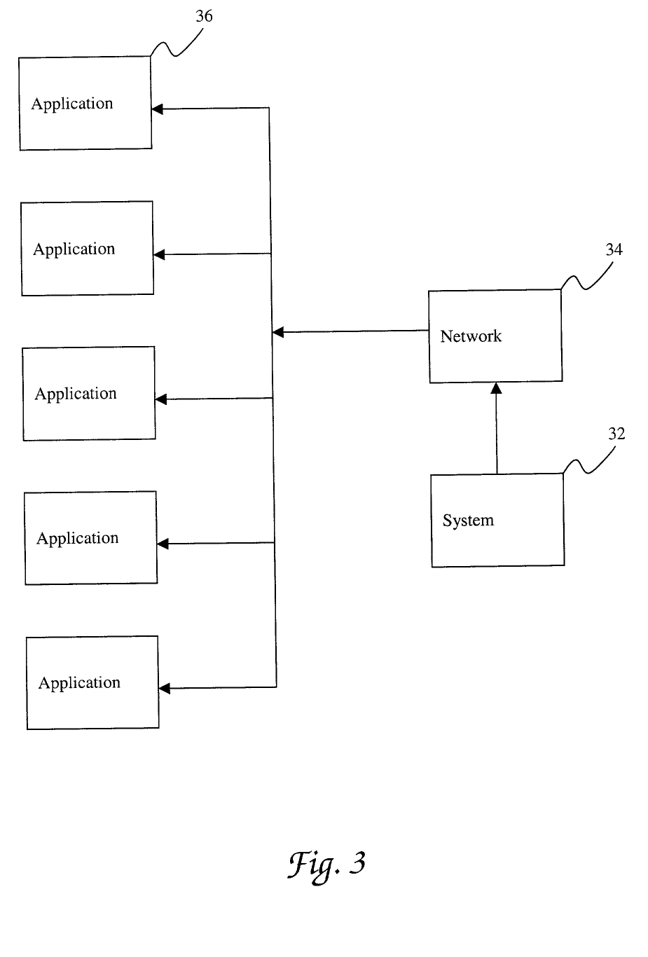

FIG. 3 shows a networked system on which an embodiment of the method and system may be used. The system 32 is a system implemented by this method as shown in FIG. 2, and it is preferred that system 32 returns a list of possible results when accessed by an application via the network 34. System 32 also accepts input over the network 34. Multiple applications 36 may access system 32 simultaneously.

### EXAMPLE 1

The following example is one way of using the invention, which can be used to establish a subject's probable position with a time argument and a reference time series of positional data of the subject. By way of example, system 32 can build the subject's mobility model by processing a time series of the subject's positional data off-line based on the mathematics of Chaos Theory. Applications 36 can access the system 32 via the network 34. Applications 36 would like to know a subject's probable position in a given time. So, applications 36 could send a time argument and a subject's reference time series of positional data to system 32 to get the subject's probable position at the given time. System 32 would manipulate the subject's mobility model then output the probable result.

### EXAMPLE 2

In another example, the system is provided as an alarm system for applications which needs to monitor certain subjects' position continuously. Applications 36 can continuously send the subjects' position tracking result to the system 32. While system 32 find some irregular positions of subjects by comparing the subjects' position tracking result with the estimated ones, system 32 will send an alarm to applications 36 for notifying applications 36.

### EXAMPLE 3

In another example, the system is provided to estimate subjects' position for the user location database in a cellular network. Applications 36 maybe the HLR/VLR in cell phone network that should keep users' location information to reach the users when there is an incoming call. Although there is a mechanism named location management in cell phone network nowadays, spontaneously massive location management requests still is a problem of network traffic resource. The system 32 could solve this problem by estimating the position of mobile users with reconstructed model and help to configure a cellular network with less location management requests, or dynamically change the network configuration for suiting different purpose.

What is claimed is:

1. A method for estimating subject position comprising:
a collecting process for collecting a set of positional data of a subject;
a modeling process for reconstructing phase space model of the positional data; and
an estimating process for estimating a most possible position of the subject at a specific time on the basis of the reconstructed model.

2. The method of claim 1 wherein the subject's definition ranges from a person to a collective of people with mobility.

3. The method of claim 1 wherein the positional data is measured by systems such as a global positioning system and a mobile communication system.

4. The method of claim 1 wherein the positional data is derived directly and indirectly from measurement on collective movements of a subject.

5. The method of claim 1 wherein the positional data is derived from mobile communicating systems' records such as handover counters and location updating counters.

6. The method of claim 1 wherein said positional data is described in spatial and temporal coordinates.

7. The collecting process of claim 1 further comprising a step for smoothing said positional data by means of an interpolation method to approximate the subject's positional data with a fixed time interval.

8. The method of claim 1 further comprising a step for dynamically updating said reconstructed model with new positional data.

9. The smoothing step of claim 8 further comprising a means for rectifying problems caused by missing data due to conditions such as communication blocks and positioning system being offline.

10. The modeling process of claim 1 comprising the steps of:
a time delay T evaluation;
an embedding dimension D evaluation; and
a phase space model reconstruction according to Takens' Embedding Theorem on the basis of said time delay T and said embedding dimension D.

11. The process of claim 10 wherein said time delay T evaluation is derived from methods with similar purpose to the calculation of the average mutual information based on said subject position data sampled with a fixed time interval.

12. The process of claim 10 wherein said embedding dimension D evaluation is derived from methods with similar purpose to singular value decomposition (SVD) based on said positional data sampled with a fixed time interval.

13. The method of claim 10 wherein said reconstructed model most preferably represents a phase characteristic of the evolution pattern embedded in said positional data.

14. The estimating process as claimed in claim 1 comprising the steps of:
a. selecting a data vector yₖ on a reconstructed phase space model which is derived from the positional data over a certain period of time;
b. selecting a plurality of a neighboring vector x on another trajectory passing through a neighbor space of the data vector yₖ according to the reconstructed model on the basis of a selecting reference that the Euclidean distance thereof is smaller than a predetermined value;
c. selecting a plurality of the next vector F(x,k) on the trajectory passing through the vector x according to the reconstructed model;
d. evaluating the next vector yₖ₊₁ on the basis of the average trend from a plurality of x to their next vector F(x,k);
e. replacing yₖ with yₖ₊₁ and repeating steps b to d until a data vector yₖ of a target time T+s is obtained, where |nT|<=|s|<=|(n+1)T|; and
f. calculating the target y(T+s) by means of interpolation between yₖ₊ₙ and yₖ₊ₙ₊₁.

15. The process of claim 14 wherein said next vector yₖ₊ₙ provides the estimated position of the subject in the future when n is a positive integer.

16. The process of claim 14 wherein said next vector yₖ₊ₙ provides the estimated position of the subject in the past when n is a negative integer.

17. The process of claim 14 further comprising a step for displaying the estimated value y(T+s).

18. A method for compressing positional data of a subject comprising the steps of:
collecting a set of positional data of a subject;
reconstructing the phase space model of the positional data;
calculating a plurality of a mapping matrix c(k,m) from x to F(x,k); and
storing each x and a correspondent c(k,m) of the collected data.

19. The reconstructed model of claim 18 most preferably represents a phase characteristic of the evolution pattern embedded in the collected data.

20. A method as claimed in claim 18 further comprising the uncompressing steps of:
a. reading all the x and their related c(m,k) from the stored file;
b. reading the starting point yₖ from the stored file;
c. selecting a plurality of a neighboring vector x on another trajectory passing through a neighbor space of the data vector yₖ according to the reconstructed model on the basis of a selecting reference that the Euclidean distance thereof is smaller than a predetermined value;
d. selecting a plurality of the next vector F(x,k) on the trajectory passing through the vector x according to the reconstructed model;
e. evaluating the next vector yₖ₊ₙ on the basis of the average trend from a plurality of x to their next vector F(x,k);
f. replacing yₖ with yₖ₊ₙ and repeating steps c to e until all the data are recovered.

21. The process of claim 20 wherein said next vector yₖ₊ₙ provides the uncompressed position of the subject in the future when n is +1.

22. The process of claim 20 wherein said next vector yₖ₊ₙ provides the uncompressed position of the subject in the past when n is −1.
